(19) United States
(12) Patent Application Publication
(10) Pub. No.: US 2026/0094073 A1
(43) Pub. Date: Apr. 2, 2026

(54) ADAPTING NETWORK EXPERIENCE PREDICTION MODELS GENERATED IN LAB ENVIRONMENTS TO DATA PATTERNS OF LOCAL CLIENT NETWORKS USING DATA DRIFT

(71) Applicant: Fortinet, Inc., Sunnyvale, CA (US)

(72) Inventors: Srikaran Shanmukha, Bangalore (IN); Zahoor Ahmed Kazi, Bangalore (IN); Siva Yogendra Jupudi, Bangalore (IN)

(73) Assignee: Fortinet, Inc., Sunnyvale, CA (US)

(21) Appl. No.: 18/902,878

(22) Filed: Sep. 30, 2024

(51) Int. Cl. G06N 20/20; H04L 41/16; H04W 24/02

(52) U.S. Cl. CPC G06N 20/20; H04L 41/16; H04W 24/02

(57) ABSTRACT

Network experience prediction models are installed on an enterprise network to label individual records as good Wi-Fi experiences and bad Wi-Fi experience for users at a local client network. A data drift level is detected to have beyond a data drift threshold for the logs and events generated on the local network relative to the previous state. Responsive to the detected drift level, a retraining of the network experience prediction model can be selectively initiated, using the newly observed data from the local client network to fill gaps identified from the previous state.

### FIELD OF THE INVENTION

The invention relates generally to computer networks, and more specifically, to adapting network experience prediction models generated in lab environments to data patterns of local client networks using data drift.

### BACKGROUND

In today's large and medium enterprise networks, network anomalies can pose significant threat to business operations and productivity. Reflexive responses to the problems thousands of Wi-Fi devices and their root causes is a significant challenge for network administrators. It is therefore necessary to identify the issues in the network proactively, by computing the network experience of the endpoints (clients) with the network transactions generated by the clients.

Network devices can be connected to a network using either wired or wireless technology, and are generally managed by IT administrators using network operation software. Wireless devices often encounter variations in network quality due to the unpredictable behavior of wireless signals, which can be affected by factors like interference, obstacles, and atmospheric conditions. Altogether, a network can generate 235 features for each wireless client (e.g., signal-to-noise ratio, channel utilization and data rates. These features vary dynamically over time due to the nonlinear nature of wireless communication and the diversity of wireless clients, further complicating the identification process.

Machine learning models for network experience prediction, are built with data generated in a lab environment, but is far from real deployment scenarios. Conventional retraining leads to unnecessary computation costs and inefficiencies.

Therefore, what is needed is a robust technique for adapting network experience prediction models generated in lab environments to data patterns of local client networks. Updates are selective.

### SUMMARY

To meet the above-described needs, methods, computer program products, and systems for adapting network experience prediction models generated in lab environments to data patterns of local client networks using data drift.

In one embodiment, a network experience prediction model is installed on an enterprise network to label individual records as good Wi-Fi experiences and bad Wi-Fi experience for users at a local client network. The network experience model is at an initial state based on a lab dataset independent of the local client network. Additionally, logs and events generated on the local client network for probabilistic network experience are machine labeled based on the model.

In another embodiment, a data drift level is detected to have moved away from trained data beyond a data drift threshold for the logs and events generated on the local network relative to the previous state. Responsive to the detected drift level, a retraining of the network experience prediction model can be initiated, using the newly observed data from the local client network to fill gaps identified from the previous state. Otherwise, retraining of the model is avoided for efficiency.

Updates to the network experience prediction model are deployed after retraining, and after verification of accuracy.

Advantageously, Wi-Fi network performance and network device efficiency are improved with targeted and efficient relearning.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for adapting network experience prediction models generated in lab environments to data patterns of local client networks, according to some embodiments.

FIG. 2 is a more detailed block diagram illustrating an AIOps server of the system of FIG. 1, according to an embodiment.

FIG. 3 is a more detailed block diagram illustrating a tunnel interface, according to an embodiment.

FIG. 4 is a high-level flow diagram of a method for adapting network experience prediction models generated in lab environments to data patterns of local client networks, according to an embodiment.

FIG. 5 details a step of triggering retraining of the model, from the method of FIG. 4, according to an embodiment.

FIG. 6 is a block diagram illustrating an example computing device for the system of FIG. 1, according to an embodiment.

### DETAILED DESCRIPTION

Methods, computer program products, and systems for adapting network experience prediction models generated in lab environments to data patterns of local client networks using data drift. The model can predict whether Wi-Fi end users have a good experience or a bad experience. The following disclosure is limited only for the purpose of conciseness, as one of ordinary skill in the art will recognize additional embodiments given the ones described herein.

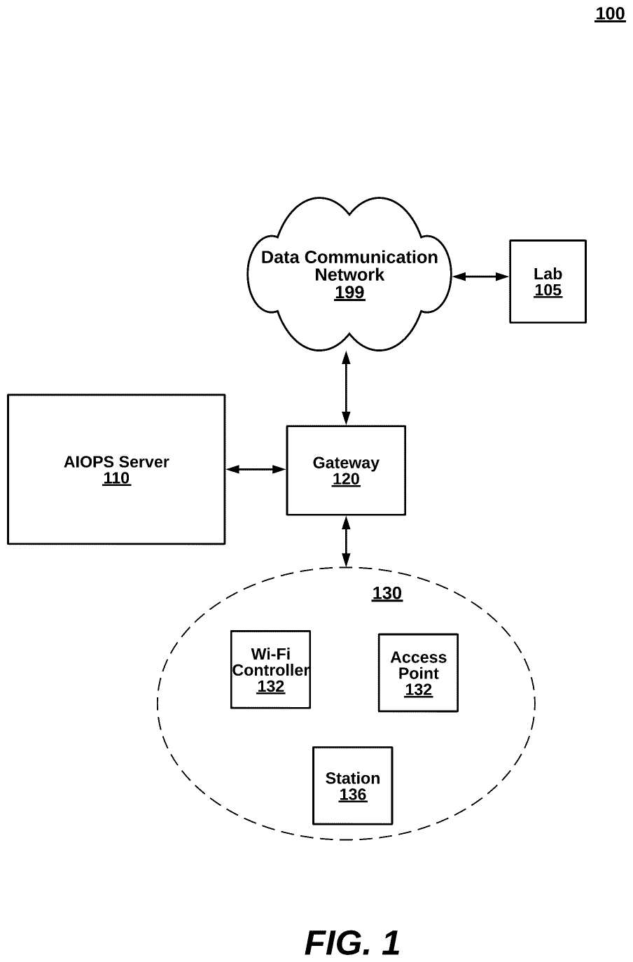

### I. Systems for Adapting Network Experience Prediction Models With Data Drift (FIGS. 1-3)

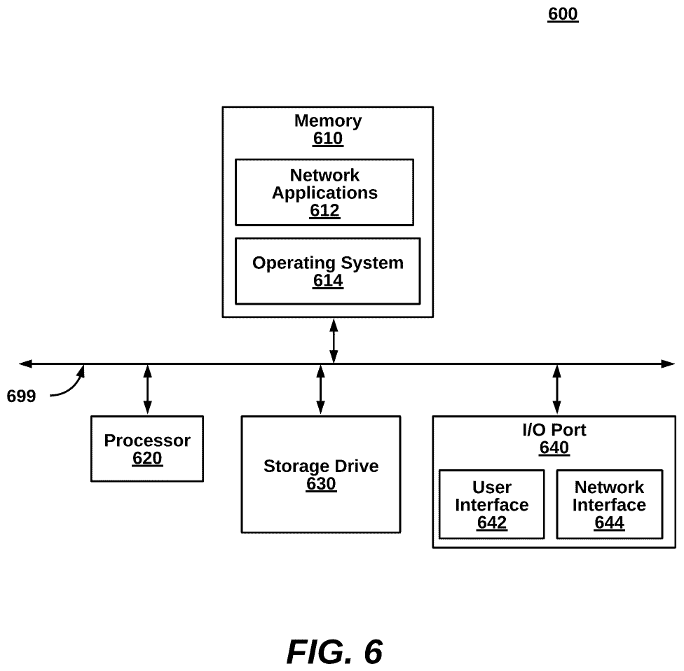

FIG. 1 is a high-level block diagram illustrating a system 100 for adapting network experience prediction models generated in lab environments to data patterns of local client networks using data drift, according to an embodiment. The system 100 includes a AIOps server 110, network gateway 120 and Wi-Fi network components 130. Other embodiments of the system 100 can include additional components that are not shown in FIG. 1, such as routers, switches, additional access points, and IT/OT/IoT devices. The components of system 100 can be implemented in hardware, software, or a combination of both. An example implementation is shown in FIG. 6.

In one embodiment, components of the system 100 are coupled in communication over a private network connected to a public network, such as the Internet. In another embodiment, system 100 is an isolated, private network, or alternatively, a set of geographically dispersed LANs. The components can be connected to the data communication system via hard wire (e.g., AIOps server 110, network gateway 120, Wi-Fi controller 132, access point 134 and station 136). The components can also be connected via wireless networking (e.g., malicious actor 99). The data communication network can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPv4 or Ipv6 address spaces.

In an embodiment, the AIOps server 110 employs data drift to retrain a network experience prediction module that was generated in a lab environment, for a local Wi-Fi network. One implementation uses Population Stability Index (PSI) to trigger retraining. Initially, the model is trained on data specific to one production environment, meaning its identified patterns are tailored to that data set. Data sets vary across different environments due to factors such as access point models, building structures, physical obstructions (e.g., large metal objects, walls and furniture) environmental factors, ISP infrastructure and more. The AIOps server 110 generates labels of Good Wi-Fi Experience and Bad Wi-Fi experience, in one implementation, that can serve as human-labeled data that is continuously improved over time as network parameters evolve. In one case, the AIOps server 110 ensures a model performance exceeds an 80% threshold prior to deployment.

The AI can implement one or more unsupervised learning techniques, such as K-Means, DBSCAN and Mean Shift. One implementation caps K-Means at 1,024 clusters to mitigate known limitations.

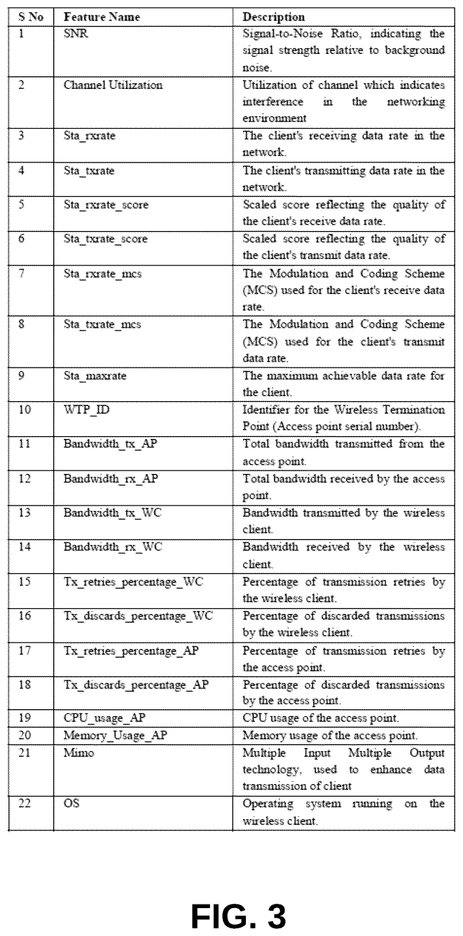

The network gateway 120 collects logs and events associated with devices of the Wi-Fi network and wired network. A minimum of 50,000 records or more may be required to effectively execute relearning. One implementation collects 235 features for each Wi-Fi client. Data can be gathered per transaction or gathered periodically in batch. Data can be directly observed or passed upstream from managed devices. Features with high null value counts, duplicate features, and configuration-related features that do not contribute to the modeling process can be removed. One implementation uses a set of 22 non-collinear and relevant features listed in FIG. 3. In another implementation, data preparation processes can include data cleaning, outlier removal, data normalization.

The Wi-Fi network components 130 create the logs and events collected upstream by the network gateway 120. The components 130 can include a Wi-Fi controller 132, an access point 134 and a station 136, as one possible configuration of many. In operation, station 136 can request a web site with a data packet sent over Wi-Fi to access point 134. The data packet can be logged or examined by the Wi-Fi controller 132 before being passed to the network gateway 120 to reach the external network.

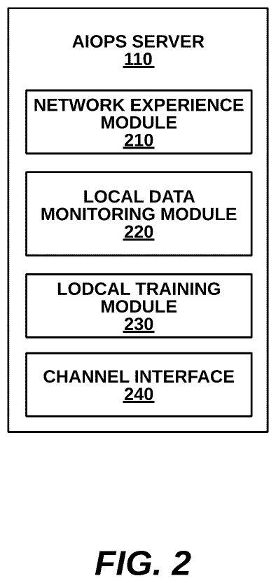

FIG. 2 is a more detailed view of the AIOps server 110 of FIG. 1, according to an embodiment. The AIOps server 110 further comprises a network experience module 210, a local data monitoring module 220, a local training module 230, and a channel interface 240.

The network experience module 210 can install and manage a network experience prediction model and label individual records as good experiences and bad experience for users at a local client network. The network experience model 210 has an initial state based on a lab dataset independent of the local client network. In some cases, a version history of models is stored. A back up can be kept to restore data damage with a rollback.

The local data monitoring module 220 can machine label logs and events generated on the local client network for probabilistic network experience. The local data monitoring module 220 detects a data drift level exceeding a data drift threshold for the logs and events generated on the local network relative to the previous state. For example, the PSI index exceeds predetermined levels or 20% of total feature set shows drift. In an embodiment, unsupervised techniques are employed to cluster data into distinct groups, assigning numerical labels accordingly.

The local training module 230, responsive to the detected drift level, initiates a retraining of the network experience prediction model, using data from the local client network to fill gaps identified from the previous state. Random Forest is one tool for retraining models. The goal is to trigger relearning, in one example, only when there are significant changes in data patterns or Wi-Fi parameters, rather than engaging in continuous retraining without clear justification. The local training module 230 deploys updates to the network experience prediction model after retraining. The updates can be conditioned upon outperforming a version it is replacing.

The channel interface 240 can include transceivers for Ethernet and Wi-Fi. Encryption/decryption, coding/decoding and other processes related to channel communications are performed. An operating system interface can send a data stream as input for the channel and receive a data stream as output from the channel.

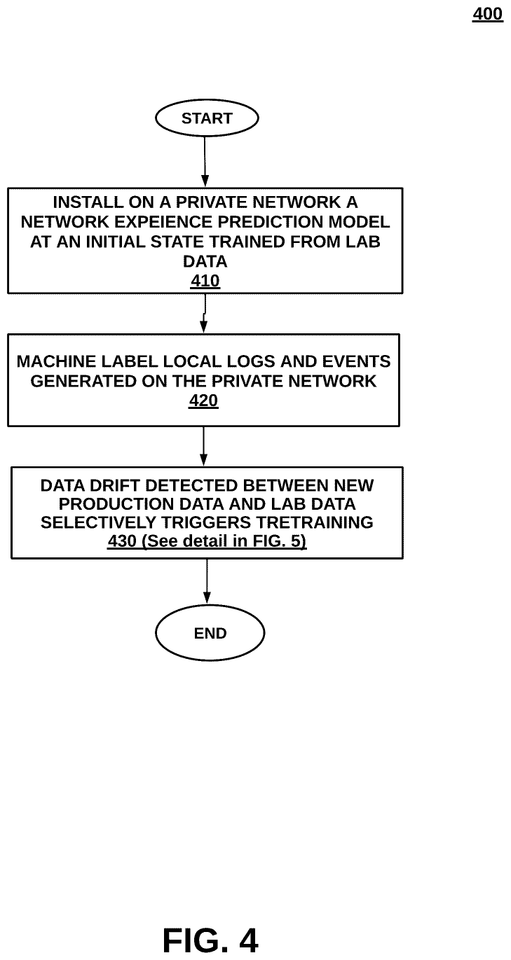

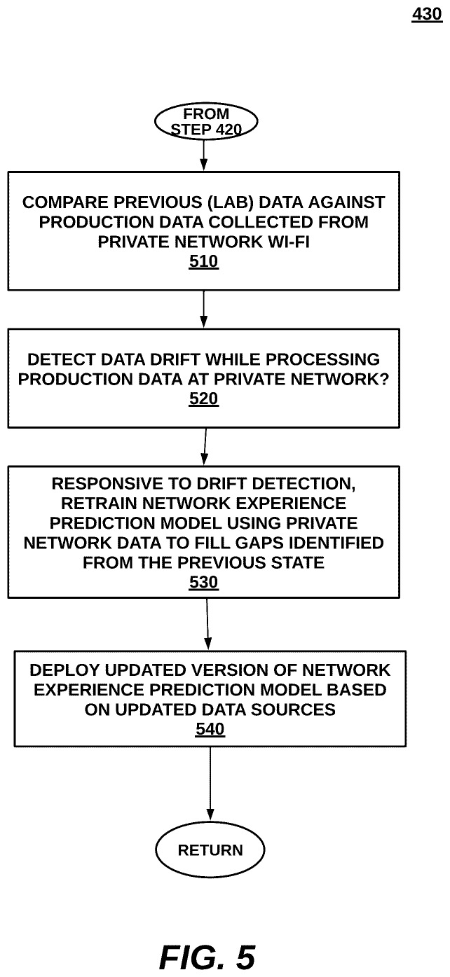

### II. Methods for Adapting Network Experience Prediction Models With Data Drift (FIGS. 4-5)

FIG. 4 is a high-level flow diagram of a method 400 for adapting network experience prediction models to data patterns of local client networks, according to an embodiment. The method 400 can be implemented by, for example, system 100 of FIG. 1. The specific grouping of functionalities and order of steps are a mere example as many other variations of method 400 are possible, within the spirit of the present disclosure. Other variations are possible for different implementations.

At step 410, a network experience prediction model is installed to label individual records as good experiences and bad experience for users at a local client network. The network experience model has an initial state based on a lab dataset independent of the local client network. At step 420, logs and events generated on the local client network are machine labeled for probabilistic network experience. At step 430, data drift detected between production data streams and model data streams selectively triggers retraining of the model, as is described more fully below.

More specifically, FIG. 5 details step 430 of triggering retraining of the model, according to an embodiment.

At step 510, the local data monitoring module detects a data drift level exceeding a data drift threshold for the logs and events generated on the local network relative to the previous state.

At step 520, responsive to the detected drift level, a retraining of the network experience prediction model is initiated, using data from the local client network to fill gaps identified from the previous state. In another embodiment, retraining is avoided while drift is within boundaries.

At step 530, updates to the network experience prediction model are deployed after retraining.

### III. Computing Device for Adapting Network Experience Prediction Models With Data Drift (FIG. 6)

FIG. 6 is a block diagram illustrating a computing device 600 for use in the system 100 of FIG. 1, according to one embodiment. The computing device 600 is a non-limiting example device for implementing each of the components of the system 100, including AIOps Server 110, network gateway 120 and network components 130. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7 or Windows 8), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 930 can be any non-volatile type of storage such as a magnetic disc, EEPROM, Flash, or the like. The storage device 930 stores code and data for access applications.

The I/O port 940 further comprises a user interface 942 and a network interface 944. The user interface 942 can output to a display device and receive input from, for example, a keyboard. The network interface 944 connects to a medium such as Ethernet or Wi-Fi for data input and output. In one embodiment, the network interface 944 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A computer-implemented method in a network device, for adapting network experience prediction models generated in lab environments to data patterns of local client networks, the method comprising:
installing a network experience prediction model to label individual records as good Wi-Fi experiences and bad Wi-Fi experience for users at a local client network, wherein the network experience model is at an initial state based on a lab dataset independent of the local client network;
machine labeling of logs and events generated on the local client network for probabilistic network experience;
detecting a data drift level from trained data to newly observe data exceeding a data drift threshold for the logs and events generated on the local network relative to the previous state;
responsive to the detected drift level, initiating a retraining of the network experience prediction model, using the newly observed data from the local client network to fill gaps identified from the previous state; and
deploying updates to the network experience prediction model after retraining.

2. The method of claim 1, further comprising:
prior to deploying updates, verifying that updates outperform previous state.

3. The method of claim 1, wherein the step of detecting the data drift from newly observed data is performed with the Population Stability Index (PSI).

4. The method of claim 1, wherein the step of machine labeling of logs and events uses K-Means clustering to generate human-like labels.

5. The method of claim 1, wherein the step of machine labeling of logs and events uses Random Forest to generate human-like labels.

6. A non-transitory computer-readable medium in a network device, storing code that when executed, performing a method for adapting network experience prediction models generated in lab environments to data patterns of local client networks, the method comprising:
installing a network experience prediction model to label individual records as good experiences and bad experience for users at a local client network, wherein the network experience model is at an initial state based on a lab dataset independent of the local client network;
machine labeling of logs and events generated on the local client network for probabilistic network experience;
detecting a data drift level exceeding a data drift threshold for the logs and events generated on the local network relative to the previous state;
responsive to the detected drift level, initiating a retraining of the network experience prediction model, using data from the local client network to fill gaps identified from the previous state; and
deploying updates to the network experience prediction model after retraining.

7. A network device for adapting network experience prediction models generated in lab environments to data patterns of local client networks, the network device comprising:
a processor;
a network interface communicatively coupled to the processor and to a data communication network; and
a memory, communicatively coupled to the processor and storing:
a network experience prediction module to install a network experience prediction model and label individual records as good experiences and bad experience for users at a local client network, wherein the network experience model has an initial state based on a lab dataset independent of the local client network;
a local data monitoring module to machine label logs and events generated on the local client network for probabilistic network experience,
wherein the local data monitoring module detects a data drift level exceeding a data drift threshold for the logs and events generated on the local network relative to the previous state;
a local training module to, responsive to the detected drift level, initiate a retraining of the network experience prediction model, using data from the local client network to fill gaps identified from the previous state,
wherein the local training module deploys updates to the network experience prediction model after retraining.
